(19) United States
(12) Patent Application Publication
(10) Pub. No.: US 2010/0295977 A1
(43) Pub. Date: Nov. 25, 2010

(54) IMAGE PROCESSOR AND RECORDING MEDIUM

(75) Inventor: Yoshitsugu MANABE, Tokyo (JP)

Correspondence Address: HOLTZ, HOLTZ, GOODMAN & CHICK PC, 220 Fifth Avenue, 16TH Floor, NEW YORK, NY, 10001-7708, US

(73) Assignee: Casio Computer Co., Ltd., Tokyo (JP)

(21) Appl. No.: 12/781,924

(22) Filed: May 18, 2010

(30) Foreign Application Priority Data
May 20, 2009 (JP) 2009-121504

(51) Int. Cl. H04N 5/202

(52) U.S. Cl. 348/254; 348/E05.074

(57) ABSTRACT

A digital camera 1 comprises a degree-of-color similarity determiner 104, a gain setter 105 and a gradation corrector 106. Degree-of-color similarity determiner 104 determines, based on color information on all pixels of each of a plurality of block areas of an image whose gradation is to be corrected, a degree of similarity of the hue of that block area to a specified reference color. Correction factor setter 105 sets, for each pixel, a correction factor corresponding to the degree of similarity of a hue of the block area determined by the determiner. Gradation corrector 106 corrects the brightness of that pixel based on the correction factor set for that pixel by the setter.

This application is based on Japanese Patent Application No. 2009-121504 filed on May 20, 2009 and including specification, claims, drawings and summary. The disclosure of the above Japanese patent applications is incorporated herein by reference in its entirety.

### BACKGROUND OF THE INVENTION

1. Field of the Invention

The present invention relates to image processing techniques including correction of a gradation of an image, for example, for use in image capturing devices of digital cameras.

2. Description of the Related Art

Conventionally, JP 2003-116049 discloses an exposure control technique for image capturing devices, including detecting a degree of backlight, using luminance levels of higher and lower luminance level areas and setting a gradation correction gain so as to increase the luminance level of the lower-luminance area in accordance with the detected degree of backlight.

According to such technique, exposure can be controlled appropriately even in the case of backlight, so that a captured image ensures good gradation. However, in this technique, the gradation is corrected by exposure control in which the same gain value is applied to a plurality of areas of the image having the same luminance level, irrespective of the respective colors of the areas. Thus, even when this technique is applied to the digital cameras, the captured image cannot be corrected with reference to respective colors and the image whose gradation has been corrected does not necessarily reflect the brightness for each color which general users prefer.

### SUMMARY OF THE INVENTION

It is therefore an object of the present invention to provide an image processor and software program product capable of appropriately correcting the brightness of each of colors of an image such as captured by a camera so as to satisfy many users.

According to one aspect of the present invention there is provided an image processor comprising: a degree-of-color similarity determiner that determines, based on color information on all pixels of each of a plurality of block areas of an image whose gradation is to be corrected, a degree of similarity of the hue of that block area to a specified reference color; a correction factor setter that sets, for each pixel, a correction factor corresponding to the degree of similarity of a hue of the block area determined by the determiner; and a gradation corrector that corrects the brightness of that pixel based on the correction factor set for that pixel by the setter.

According to another aspect of the present invention there is provided a software program product embodied in a computer readable medium for causing a computer to function as: a degree-of-color similarity determiner that determines, based on color information on all pixels of each of a plurality of block areas of an image whose gradation is to be corrected, a degree of similarity of the hue of that block area to a specified reference color; a correction factor setter that sets, for each pixel, a correction factor corresponding to the degree of similarity of a hue of the block area determined by the determiner; and a gradation corrector that corrects the brightness of that pixel based on the correction factor set for that pixel by the setter.

### BRIEF DESCRIPTION OF THE DRAWINGS

The above set forth and other features of the invention are made more apparent in the ensuing DETAILED DESCRIPTION of the INVENTION when read in conjunction with the attached DRAWINGS, wherein:

FIG. 1 is a block diagram of one example of a hardware structure of a digital camera according to the present invention.

FIG. 2 is a functional block diagram of the digital camera.

FIG. 3 is a functional block diagram of an essential part of an image processor of the camera.

FIG. 4A illustrates block areas of an image whose gradation is to be corrected.

FIG. 4B illustrates a method of calculating a correction gain for a peripheral pixel of a block area of the image.

FIG. 5 illustrates a specified method of the calculating method of FIG. 4B.

FIGS. 6A and B each illustrate an example of a characteristic of basis gain level vs change in an averaged value value.

FIG. 7 is a flowchart indicative of a gain setting process to be performed in a gradation correction process by an image sub-processor of the camera.

FIG. 8 is a flowchart indicative of a degree-of-color similarity determining process to be performed in the gain setting process.

FIG. 9 is a flowchart indicative of a degree-of-skin color similarity determining process to be performed in the degree-of-color similarity determining process.

FIG. 10 is a flowchart indicative of a degree-of-green color similarity determining process to be performed in the degree-of-color similarity process.

FIG. 11 is a flowchart indicative of a degree-of-blue color similarity determining process to be performed in the degree-of-color similarity determining process.

FIG. 12 is a flowchart indicative of a correction of a skin color gain process to be performed in the gain setting process.

FIG. 13 is a flowchart indicative of a correction of a green color gain process to be performed in the gain setting process.

FIG. 14 is a flowchart indicative of a correction of a blue color gain process to be performed in the gain setting process.

### DETAILED DESCRIPTION OF THE INVENTION

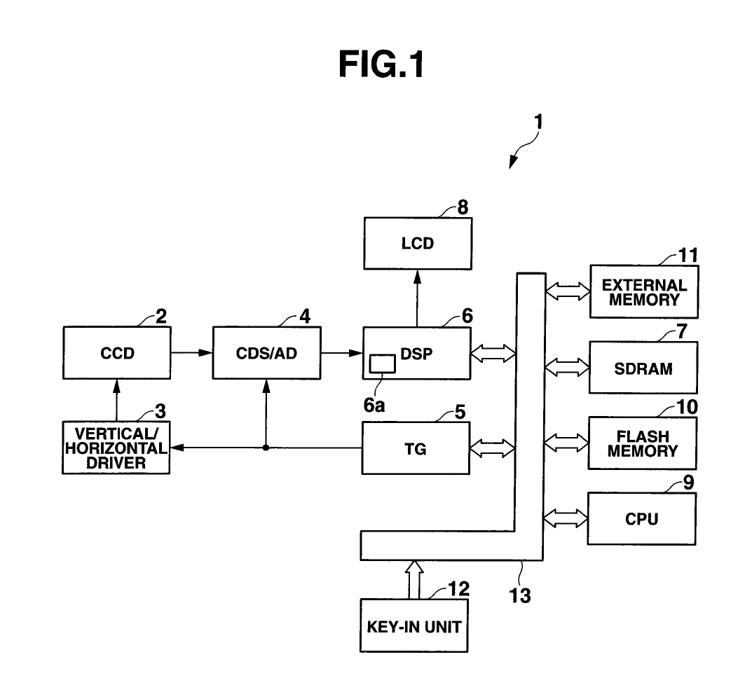

An embodiment of the present invention will be described with reference to the accompanying drawings. FIG. 1 is a block diagram of a schematic hardware structure of a digital still camera 1 according to the present invention.

As shown in FIG. 1, digital camera 1 comprises a CCD (Charge Coupled Device) 2 which captures an image of a subject. CCD 2 comprises color filters of a specified color arrangement such as a Bayer arrangement on a photosensitive face thereof on which an optical image of the subject is focused by an optical system (not shown). CCD 2 is driven by horizontal and vertical transfer drive signals outputted by a horizontal/vertical driver 3 to convert the optical image of the subject to an electric signal, which is then outputted as a captured image signal to a CDS/AD circuit 4 composed of a CDS (Correlated Double Sampling) circuit and an A/D (Analog-to-Digital) converter.

Horizontal/vertical driver 3 operates in accordance with timing signals produced by a TG (timing Generator) 5 to produce the horizontal and vertical transfer drive signals, thereby driving CCD 2. The timing signals produced by TG 5 are also outputted to CDS/AD circuit 4, which operates in accordance with the timing signals from TG 5, thereby eliminating noise included in the captured image signal outputted by CCD 2. CDS/AD circuit 4 converts a resulting noiseless image signal to a digital signal, which is then outputted to a DSP (Digital Signal Processor) 6.

DSP 6 comprises a buffer memory 6a which is used to process a digital signal of pixel data each having information on a single color received from CDS/AD circuit 4. DSP 6 performs a de-mosaic process on a digital signal received from CDS/AD circuit 4. The de-mosaic process interpolates color information, which each of the pixels of the digital signal lacks, from the peripheral pixels, thereby producing RGB data having R (Red), G (Green) and B (Blue) color information for that pixel.

DSP 6 performs a digital signal processing process including a gradation correction process on the image represented by the RGB data produced in the de-mosaic process; a white balance adjusting process, a gamma correction process, and various filtering processes on the resulting RGB data; and a YUV conversion process in which the RGB data is converted for each pixel to YUV data represented by a luminance component Y and two color difference components Cb, Cr. Note that the details of the gradation correction process will be described later.

Then, DSP 6 sequentially outputs the YUV data to a SDRAM (Synchronous Dynamic Random-Access Memory) 7, which temporarily stores the YUV data received from DSP 6.

When digital camera 1 is in a record mode and each time this YUV data is stored in SDRAM 7, DSP 6 reads this YUV data from SDRAM 7 and outputs it to a display 8.

Display 8 is composed of a liquid crystal display sub-unit (not shown) and a driver (not shown either) for driving the liquid crystal display sub-unit. Display 8 displays an image, based on the YUV data received from DSP 6, as a live view image on display 8.

TG 5 and DSP 6 are connected via a bus 13 to a CPU (Central Processing Unit) 9 so as to be controlled by CPU 9.

CPU 9 controls the whole operation of digital camera 1 in accordance with a program stored in a flash memory 10 which comprises an EEPROM (Electric Erasable Programmable Read Only Memory) whose stored data is rewritable.

When digital camera 1 captures an image of a subject in the record mode, CPU 9 compresses the YUV data stored temporarily in SDRAM 7 in accordance with a predetermined compressing system such as JPEG (Joint Photographic Expert Group), and then stores resulting compressed YUV data as an image file in an external memory 11, which comprises a memory card inserted into camera 1 connected to bus 13 via a card interface (not shown).

When digital camera 1 is in a playing mode, CPU 9 reads a predetermined image file (of compressed YUV data) from external memory 11 as required, extends the read data and then loads it on SDRAM 7. Further, CPU 9 outputs this YUV data to display 8 via DSP 6, thereby displaying a recorded image on display 8.

Connected to bus 13 is a key-in unit 12, which includes various keys required to operate digital camera 1, such as, for example, a power source key, a shutter key, and mode setting keys for setting a record and a playing mode. CPU 9 sequentially detects operated states of the respective keys, and then performs various processes in accordance with the program and user's request based on the detected operated states of the keys.

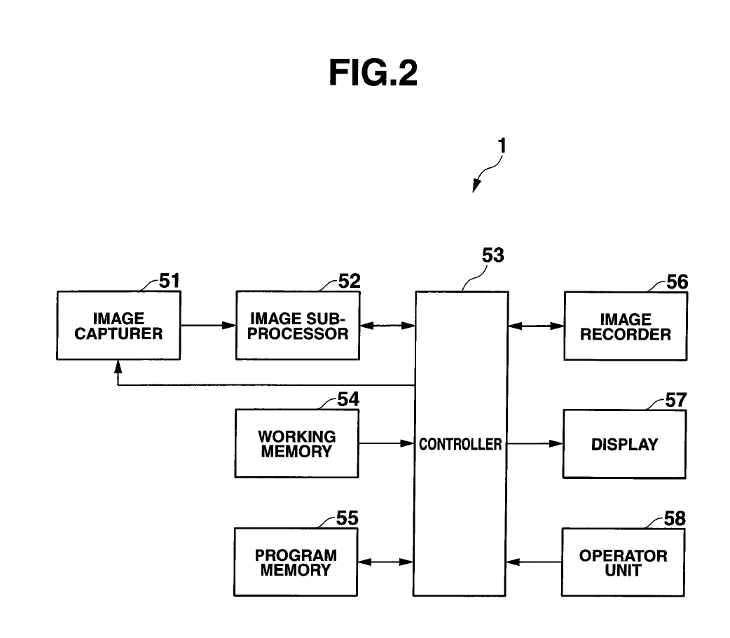

FIG. 2 is a functional block diagram of digital camera 1. As shown in FIG. 2, digital camera 1 mainly comprises an image capturer 1, an image sub-processor 52, a controller 53, a working memory 54, a program memory 55, an image recorder 56, a display 57, and an operator unit 58.

Each functional block is composed of one or more hardware devices of FIG. 1. Image capturer 51 includes CCD 2, horizontal/vertical driver 3, CDS/AD circuit 4 and TG 5 to capture an image of a subject. Image sub-processor 52 comprises DSP 6 which performs various image processes on a captured image. Controller 53 comprises CPU 9. Working memory 54 comprises SDRAM 7. Program memory 55 comprises flash memory 10. Image recorder 56 comprises external memory 11. Display 57 comprises display 8. Operator unit 58 comprises key-in unit 12.

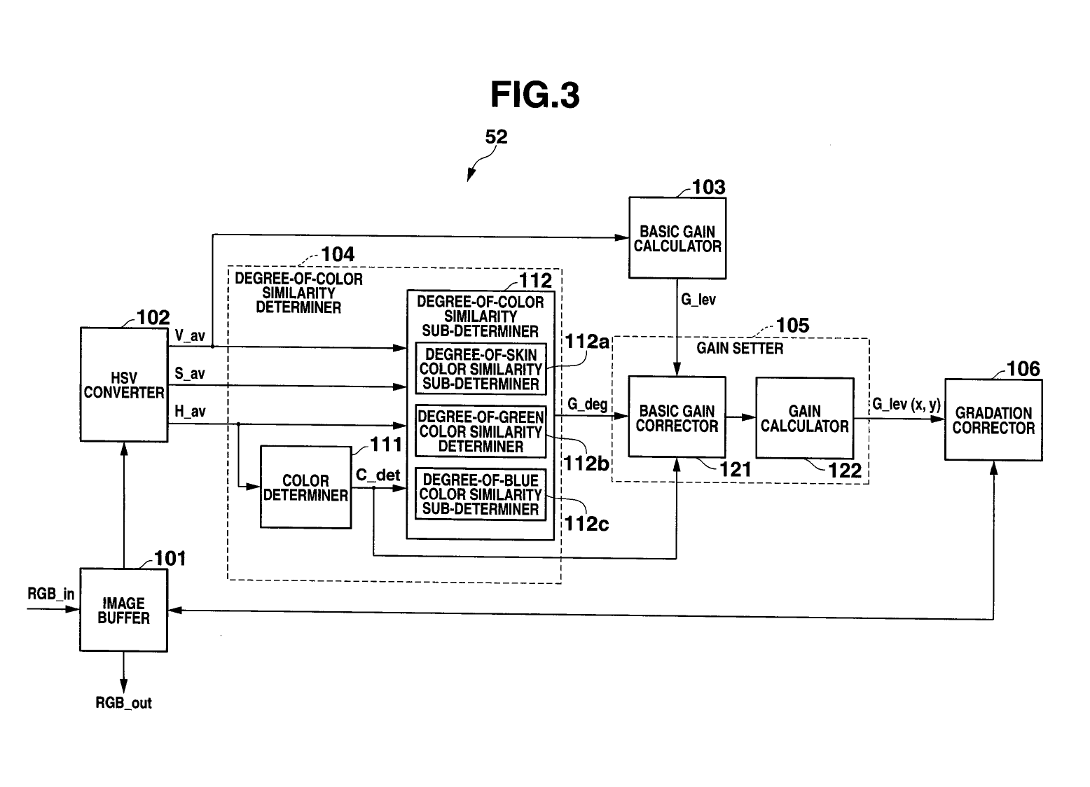

FIG. 3 is a functional block diagram indicative of the details of an essential part of image sub-processor 52 which performs a gradation correction process on an image represented by the RGB data produced in the de-mosaic process. As shown in FIG. 3, image sub-processor 52 comprises an image buffer 101, an HSV converter 102, a basis gain calculator 103, a degree-of-color similarity determiner 104, a gain setter 105, and a gradation corrector 106.

Image buffer 101 comprises a memory 6a (FIG. 1) which stores RGB data RGB_in produced in the de-mosaic process.

HSV converter 102 reads RGB data stored in image buffer 101, and then converts the read RGB data to HSV data in a HSV color space defined by hue, saturation and value. In greater detail, HSV converter 102 converts the respective R, G and B component values for each pixel to a hue value H, a saturation value S and a value value V. The converted hue, saturation and value values are in the ranges of 0-359, 0-255 and 0-255, respectively.

HSV converter 102 divides an image, whose gradation is to be corrected, into a predetermined number of block areas and calculates three averaged color attribute values; i.e., an averaged hue value H_av, an averaged saturation value S_av and an averaged value value V_av of all pixels of each block area.

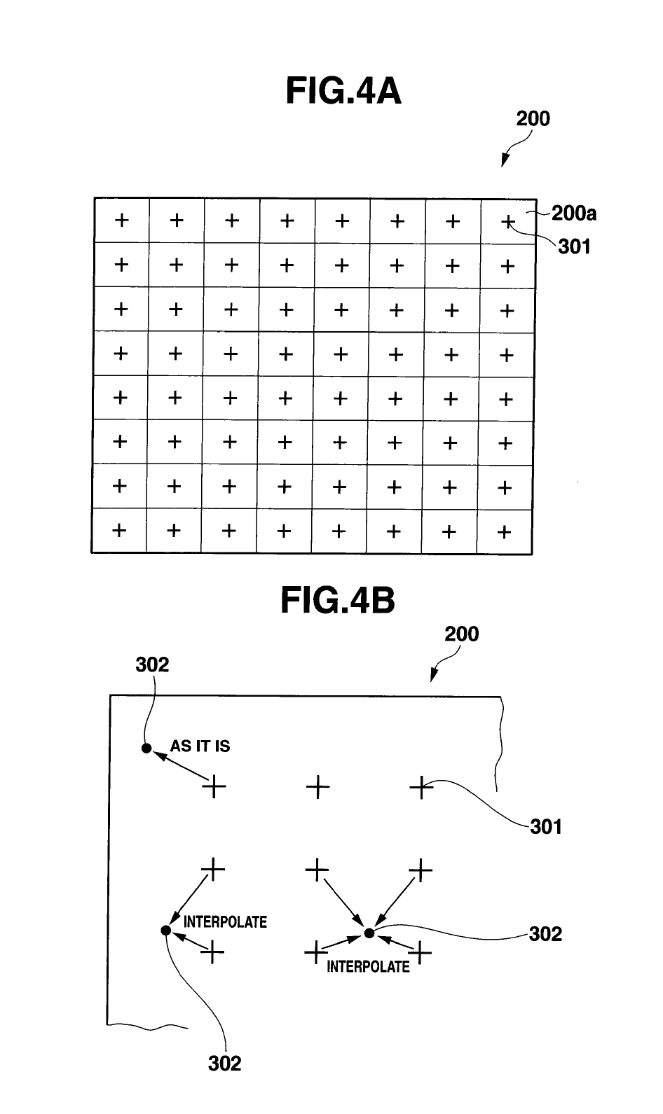

FIG. 4A illustrates block areas 200a of an image 200, whose gradation is to be corrected, from each of which block area HSV converter 102 calculates the three averaged color attributes values H_av, S_av, and V_av. As shown in FIG. 4A, HSV converter 102 handles each of 64 (=8 horizontal×8 vertical) block areas 200a into which image 200 of interest is divided.

Then, HSV converter 102 outputs the three averaged color attribute values H_av, S_av, and V_av of each block area to the degree-of-color similarity determiner 104 and also outputs only averaged value value V_av of that block to basis gain calculator 103.

Basis gain calculator 103 functions as a basis gain acquirer. Basis gain calculator 103 calculates, for each block area, a basis gain G_lev as a correction reference for the brightness of each of the pixels of that block area, using a predetermined gain function:

f_gain(V_av)

which has an averaged value value V_av as a parameter for that block area received from HSV converter 102. Basis gain calculator 103 outputs a result of the calculation to a basis gain corrector 121 to be described later in greater detail.

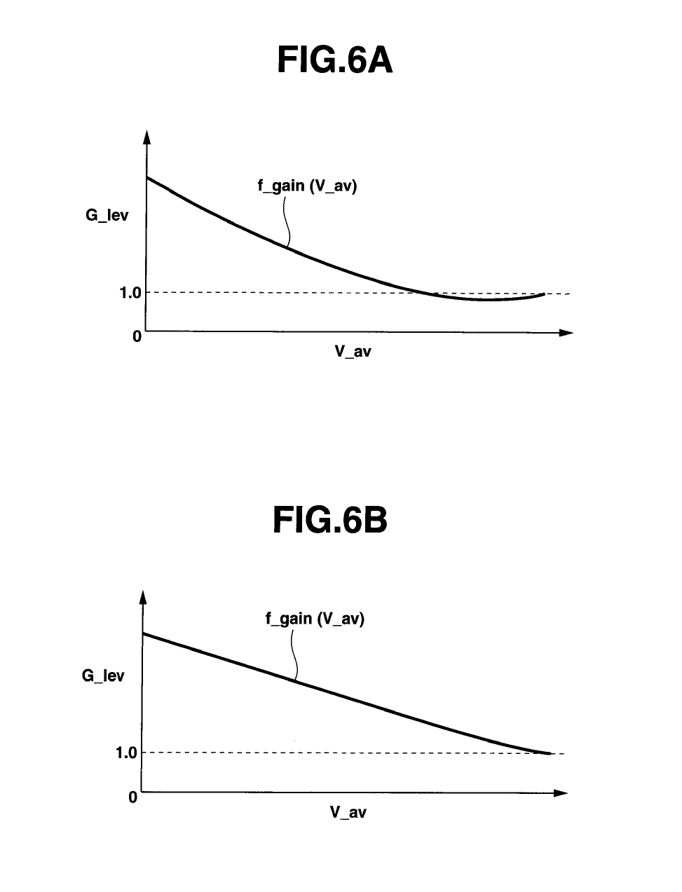

The above-mentioned gain function has a characteristic of correction whose basis gain G_lev basically increases as average value value V_av decreases and vice versa. More specifically, in the gain function, for example, basis gain G_lev changes, for example, as shown in FIG. 6A or 6B as averaged value value V_av changes.

Degree-of-color similarity determiner 104 is comprised of a color determiner 111 and a degree-of-color similarity sub-determiner 112, as shown in FIG. 3. This sub-determiner 112 is comprised of a degree-of-skin color similarity sub-determiner 112a, a degree-of-green color similarity sub-determiner 112b and a degree-of-blue color similarity sub-determiner 112c.

Color determiner 111 determines, based on averaged hue value H_av received from HSV converter 102 and in accordance with predetermined color determination criteria, which of reference skin, green, blue and other colors, the hue of each of the block areas of the image of interest corresponds to. Then, color determiner 111 outputs color data C_det indicative of a result of the determination to degree-of-color similarity sub-determiner 112 and basis gain corrector 121. The details of the color determination criteria used in color determiner 111 will be described later.

When the hue of the color of the block area determined by color determiner 111 involves one of the skin, green and blue colors, degree-of-similarity sub-determiner 112 causes an appropriate one of degree-of-skin color similarity sub-determiner 112a, degree-of-green color similarity sub-determiner 112b, and degree-of-blue color similarity sub-determiner 112c to determine a degree of similarity of the hue of that block area to a corresponding one of the reference skin, green and blue colors based on the three different averaged color attribute values H_av, S_av, V_av of that block area received from HSV converter 102, and determined color data C_det received from color determiner 111.

More specifically, when determined color data C_det involves skin color, degree-of-skin color similarity sub-determiner 112a determines the degree of similarity of the hue of that block area to the reference skin color. Similarly, when the color data C_det determined by color determiner 111 involves green or blue color, degree-of-green or blue color similarity sub-determiner 112b or 112c performs a corresponding determination.

The details of the degree-of-skin, green and blue color similarity determination criteria for degree-of-skin, green and blue color similarity sub-determiners 112a, 112b and 112c will be described later.

When the color data C_det determined by color determiner 111 involves one of the skin, green and blue colors, degree of color similarity sub-determiner 112 causes the appropriate one of degree-of-skin color sub-determiners 112a, degree-of-green color similarity sub-determiner 112b and degree-of-blue color similarity sub-determiner 112c to forwards, to gain setter 105, data C_deg indicative of the degree of similarity of the hue of the block area to the corresponding one of the reference skin, green and blue colors determined by the appropriate one of these sub-determiners 112a, b and c.

Gain setter 105 is comprised of a basis gain corrector 121 and a gain calculator 122, as shown in FIG. 3.

Basis gain corrector 121 corrects a basis gain G_ref for each of the block areas of the image of interest received from basis gain calculator 103, based on determined color data C_det received from color determiner 111 and degree-of-color similarity data C_deg received from degree-of-color similarity sub-determiner 112. Then, basis gain corrector 121 functions as a representative corrected factor acquirer by forwarding a corrected basis gain to gain calculator 122. A specified method of correcting the basis gain in basis gain corrector 121 will be described later.

Gain calculator 122 calculates a correction gain for each of the pixels of the block area based on a corrected basis gain for the block area received from basis gain corrector 121. Gain calculator 122 forwards a calculated correction gain G_lev (x, y) for that pixel to gradation corrector 106 and hence functions as a factor acquirer.

A method of calculating a gain for that pixel in gain calculator 122 will be described with reference to FIG. 4. First, gain calculator 122 handles the corrected basis gain for that block area 200a, received from basis gain corrector 121, as a representative gain for that block area. Then, gain calculator 122 determines this representative gain as a correction gain for central pixel 301 shown by “+” in FIG. 4A.

Gain calculator 122 acquires a correction gain for a (peripheral) pixel 302 in a block area, shown by “•” in FIG. 4B, by interpolation from correction [0057] Gain calculator 122 acquires a correction gain for a (peripheral) gains for central pixels 301 in four block areas at maximum close or adjacent to that peripheral pixel 302.

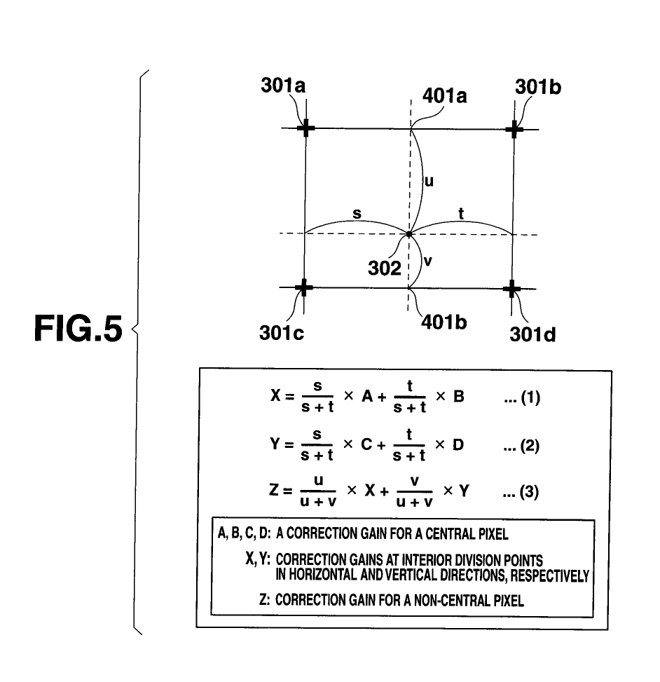

FIG. 5 illustrates a specified method of calculating a correction gain for peripheral pixel 302 by interpolation from correction gains for four central pixels 301a, 301b, 301c and 301d adjacent to that peripheral pixel 302.

First, among four central pixels 301a, 301b, 301c and 301d, gain calculator 122 calculates an interior division ratio s:t at which peripheral pixel 302 internally divides each of a line segment connecting a pair of central pixels 301a and 301b, arranged in a horizontal direction and another line segment connecting a second pair of central pixels 301c and 301d arranged also in the horizontal direction so as to align with the first pair of central pixels 301a and 301b both in the horizontal and vertical directions. Similarly, gain calculator 122 calculates an interior division ratio u:v at which peripheral pixel 302 internally divides each of a line segment connecting a pair of central pixels 301a and 301c arranged in a vertical direction and another line segment connecting a second pair of central pixels 301b and 301d arranged also in the vertical direction.

Then, in accordance with expression (1) of FIG. 5, gain calculator 122 calculates a correction gain X at a point 401a which internally divides, at interior division ratio s:t, the horizontal line segment connecting central pixels 301a and 301b arranged in the horizontal direction. That is, gain calculator 122 calculates correction gain X at interior division point 401a by adding correction gains A and B for central pixels 301a and 301b at a ratio corresponding to the interior division ratio s:t in the horizontal direction. Similarly, in accordance with expression (2) of FIG. 5, gain calculator 122 also calculates a correction gain Y at a point 401b which internally divides the horizontal-direction line segment connecting central pixels 301c and 301d arranged in the horizontal direction, at interior division ratio s:t. That is, gain calculator 122 calculates correction gain Y at interior division point 401b by adding correction gains C and D for central pixels 301c and 301d at a ratio corresponding to internal division ratio s:t in the horizontal direction.

Then, gain calculator 122 calculates a correction gain Z for peripheral pixel 302 in accordance with an expression (3) of FIG. 5. That is, gain calculator 122 calculates correction gain Z by adding correction gains X and Y at internal division points 401a and 401b, respectively, at a ratio corresponding to internal division ratio u:v in the vertical direction.

As shown in FIG. 4B, gain calculator 122 acquires a correction gain for a peripheral pixel 302 of each of block areas 200a of image 200 of interest adjacent to its upper and lower, right and left sides excluding its four corner block areas by interpolation from correction gains for two central pixels 301 adjacent to that peripheral pixel 302 excluding peripheral pixels in the block areas at the four corners of the image. As a correction gain for a peripheral pixel 302 within each of four block areas 200a at the upper, lower, right and left corners of image 200, gain calculator 122 also exceptionally uses a correction gain, as it is, for a central pixel 301 of that block area 200a which contains that peripheral pixel 302. Gain calculator 122 also exceptionally uses a correction gain for a central pixel 301 of each of block areas 200a adjacent to a respective one of the upper, lower, right and left sides of the image as a correction gain for that peripheral pixel 302 of that block area positioned outside central pixel 301 in that block area in the same horizontal or vertical direction position as that central pixel.

In order to interpolate the correction gain for peripheral pixel 302 in gain calculator 122, use may be made of a linear interpolation or spline interpolation which is generally used to interpolate pixels of an image when same image is enlarged.

Gradation corrector 106 reads RGB data stored in image buffer 101 for each pixel. Gradation corrector 106 then multiplies each of the color component (R, G and B) values of the read RGB data of that pixel by the correction gain for that pixel received from gain calculator 122. Gradation corrector 106 and hence image sub-processor 52 also rewrite the original RGB data RGB_in of that pixel stored in image buffer 101 with the corrected RGB data, thereby correcting the gradation of the image.

Image sub-processor 52 reads corrected RGB data RGB_out stored in image buffer 101. Then, image sub-processor 52 performs a digital signal processing process such as a white balance adjusting process on an image of the read RGB data whose gradation has been corrected.

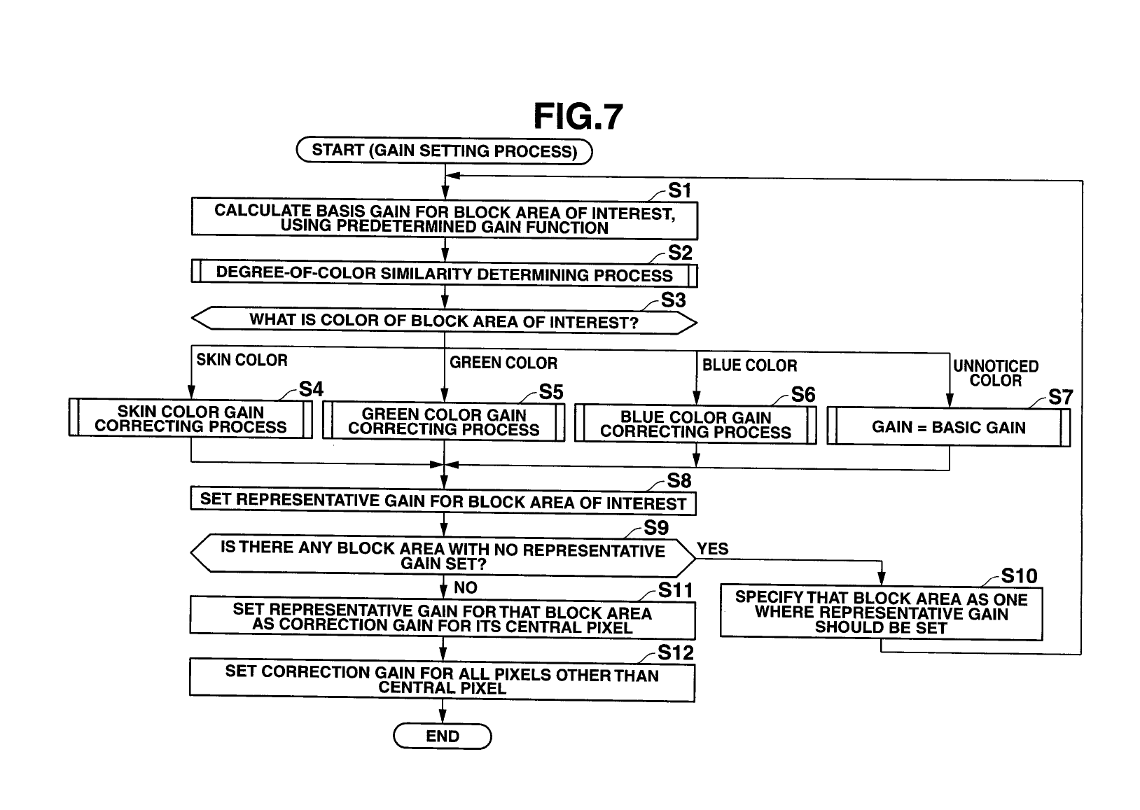

FIG. 7 is a flowchart indicative of a process for setting a correction gain for each of the pixels of the image, whose gradation is to be corrected, in a gradation correction process for the RGB data produced in the de-mosaic process.

In the gain setting process, first, image sub-processor 52 sets respective block areas 200a of image 200 of interest as being processed sequentially, as shown in FIG. 4A. Image sub-processor 52 performs a series of steps S1-S10 on each of the set block areas.

More particularly, in image sub-processor 52, basis gain calculator 103 calculates a basis gain. G_lev for a block area to be processed, using the above-mentioned predetermined gain function, with an averaged value value V_av of the block area as a parameter (step S1).

Image sub-processor 52 performs a degree-of-color similarity determining process in degree-of-color similarity determiner 104 based on the three averaged color attribute values H_av, S_av, V_av of the block area acquired by HSV converter 102 (step S2).

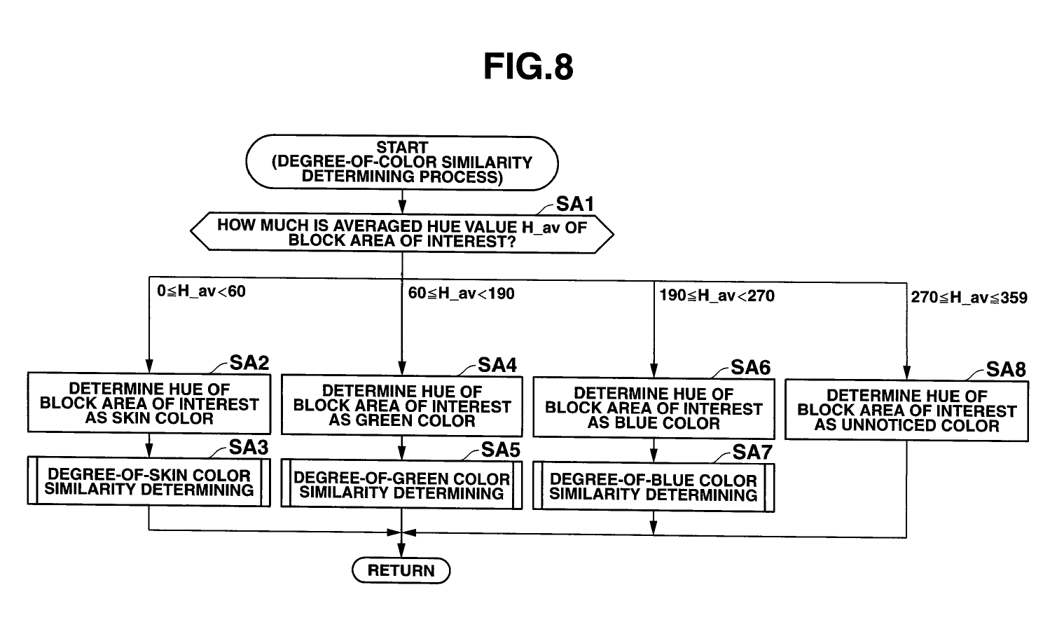

In this process, image sub-processor 52 confirms an averaged hue value H_av of the block area, as shown in FIG. 8 (step SA1), and then performs the following steps depending on the confirmed averaged hue value H_av.

If averaged hue value H_av is in a range of not less than 0 and less than 60 (0≦H_av<60), image sub-processor 52 determines that the block area has skin color (step SA2), performs a degree-of-skin color similarity determining process (step SA3), and then move on to step S3 of FIG. 7. If averaged hue value H_av is in a range of not less than 60 and less than 190 (60≦H_av<190), image sub-processor 52 determines that the block area is green color (step SA4), performs a degree-of-green color similarity determining process (step SA5), and then move on to step S3 of FIG. 7. If averaged hue value H_av is in a range of not less than 190 and less than 270 (190≦H_av<270), image sub-processor 52 determines that the hue of the block area is blue color (step SA6), performs a degree-of-blue color similarity determining process (step SA7), and then move on to step S3 of FIG. 7. If averaged hue value H_av is in a range of not less than 270 and not greater than 359 (270≦H_av≦359), image sub-processor 52 determines that the hue of the block area is non-processed color (step SA8), and then move on to step S3 of FIG. 7.

Steps SA1, SA2, SA4, SA6 and SA6 are performed by color determiner 111 of degree-of-color similarity determiner 104. Steps SA3, SA5 and SA7 are performed by a degree-of-similarity sub-determiner 112 of color similarity-degree determiner 104.

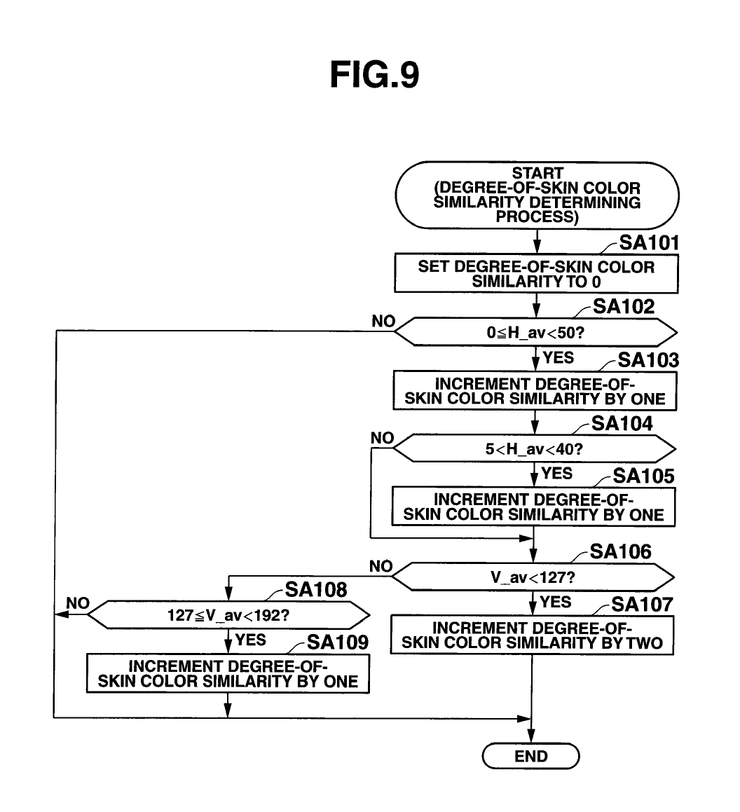

In the degree-of-skin color similarity determining process in step SA3 of FIG. 8, image sub-processor 52 first sets a degree of skin color similarity to “0” in memory 6a, as shown in FIG. 9 (step SA101). If averaged hue value H_av is not less than 50 (step SA102; NO), image sub-processor 52 immediately move on to step S3 of FIG. 7. If averaged hue value H_av is less than 50 (step SA102; YES), image sub-processor 52 increments a degree of skin color similarity by one (step SA103). If averaged hue value H_av is greater than 5 and less than 40 (step SA104; YES), image sub-processor 52 further increments the degree of skin color similarity by one (step SA105).

Subsequently, when averaged value value V_av of the block area is less than 127 (step SA106: YES), image sub-processor 52 further increments the degree of skin color similarity by 2 (step SA107), and then move on to step S3 of FIG. 7. When averaged value value V_av is not less than 127 (step SA106; NO), image sub-processor 52 checks whether averaged value value V_av is in a range of not less than 127 and less than 192 (step SA108). If so, image sub-processor 52 further increments the degree of skin color similarity by 1 (step SA109), and then move on to step S3 of FIG. 7. Conversely, if averaged value value V_av of the block area is not in a range of not less than 127 and less than 192 (step SA108; NO), image sub-processor 52 then move on to step S3 of FIG. 8.

That is, in the degree-of-skin color similarity determining process, image sub-processor 52 determines, based on averaged hue value H_av and averaged value value V_av, which of levels “0”-“4” the degree of similarity of the hue of the block area of interest to a reference skin color corresponds to.

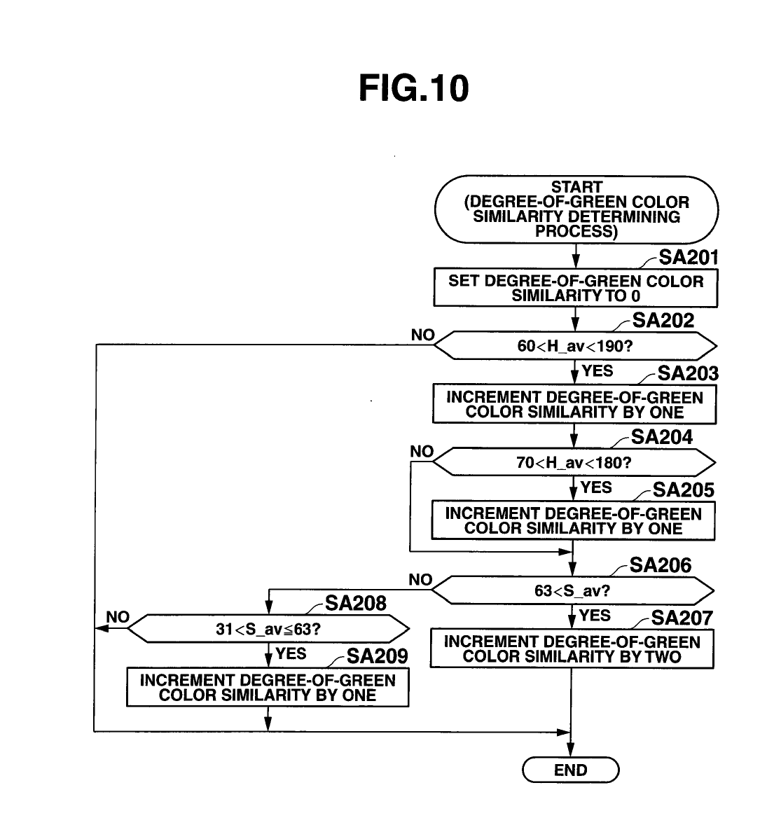

In the degree-of-green color similarity determining process in step SA5 of FIG. 8, or in FIG. 10, image sub-processor 52 first sets the degree of green color similarity to “1” in memory 6a (step SA201). Then, if averaged hue value H_av is not in a range of greater than 60 and less than 190 (step SA202; NO), image sub-processor 52 immediately move on to step S3 of FIG. 7. If averaged hue value H_av is in a range of greater than 60 and less than 190 (step SA202, YES), image sub-processor 52 increments the degree of green color similarity by one (step SA203). If, averaged hue value H_av is in a range of greater than 70 and less than 180 (step SA204; YES), image sub-processor 52 further increments the degree of green color similarity by one (step SA205).

Subsequently, if averaged saturation value S_av of the block area is greater than 63 (step SA206; YES), image sub-processor 52 further increments the degree of green color similarity by two (step SA207), and then move on to step S3 of FIG. 7. If averaged saturation value S_av of the block area is not greater than 63 (step SA206; NO), image sub-processor 52 checks whether averaged saturation value S_av is in a range of greater than 31 and not greater than 63 (step SA208). If averaged saturation value S_av of the block area is in a range of greater than 31 and not greater than 63 (step SA208; YES), image sub-processor 52 further increments the degree of green color similarity by one (step SA209) and then move on to step S3 of FIG. 7. Conversely, if averaged saturation value S_av of the block area is not in a range of greater than 31 and not greater than 63 (step SA208; NO), image sub-processor 52 then move on to step S3 of FIG. 7.

That is, in the degree-of-green color similarity determining process, image sub-processor 52 determines, based on averaged hue value H_av and averaged saturation value S_av, which of levels “0”-“4” the degree of similarity of the hue of the block area of interest to a reference green color corresponds to.

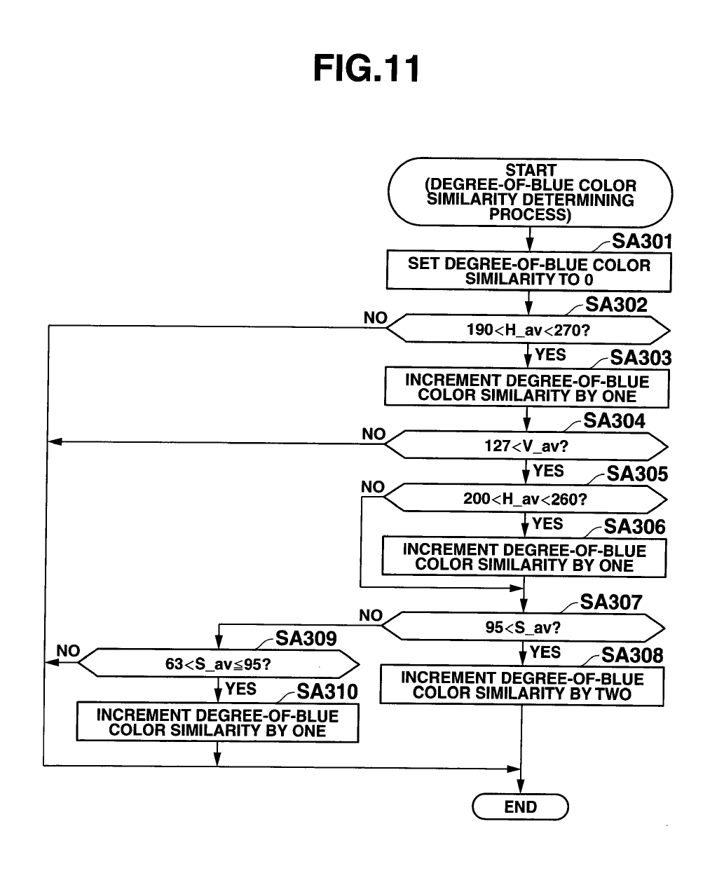

In the degree-of-blue color similarity determining process in step SA4 of FIG. 8, or as shown in FIG. 11, image sub-processor 52 first sets the degree of blue color similarity to “0” in memory 6a (step SA301). Then, if averaged hue value H_av of the block of interest is not in a range of greater than 190 and less than 270 (step SA302; NO), then image sub-processor 52 immediately move on to step S3 of FIG. 7. If averaged hue value H_av is in a range of greater than 190 and less than 270 (step SA302; YES), image sub-processor 52 increments the degree of blue color similarity by one (step SA303). Then, if averaged value value V_av of the block area is not greater than 127 (step SA304; NO), image sub-processor 52 move on to step S3 of FIG. 7.

If averaged value value V_av of the block area is greater than 127 (step SA304; YES), and averaged hue value H_av is in a range of greater than 200 and less than 260 (step SA305; YES), image sub-processor 52 further increments the degree of blue color similarity by one (step SA306). If averaged saturation value S_av of the block area is greater than 95 (step SA307; YES), image sub-processor 52 further increments the degree of blue color similarity by two (step SA308), and then move on to step S3 of FIG. 7.

When averaged saturation value S_av is not greater than 95 (step SA307; NO), image sub-processor 52 checks whether averaged saturation value S_av is in a range of greater than 63 and not greater than 95 (step SA309). If so (step SA309; YES), image sub-processor 52 further increments the degree of blue color similarity by one (step SA310) and then move on to step S3 of FIG. 7. Conversely, if averaged saturation value S_av is not in a range of greater than 63 and not greater than 95 (step SA309; NO), image sub-processor 52 move on to step S3 of FIG. 7.

That is, in the degree-of-blue color similarity determining process, image sub-processor 52 determines, based on averaged hue value H_av, averaged value value V_av, and averaged saturation value S_av, which of levels “0”-“4” the degree of blue color similarity of the block area of interest corresponds to.

After performing the degree-of-color similarity determining process of FIG. 7 including the degree-of-skin color similarity determining process (FIG. 9), the degree-of-green color similarity determining process (FIG. 10), and the degree-of-blue color similarity determining process (FIG. 11), image sub-processor 52 then move on to step S3 of FIG. 7 and subsequently basis gain corrector 121 performs steps S3-S7.

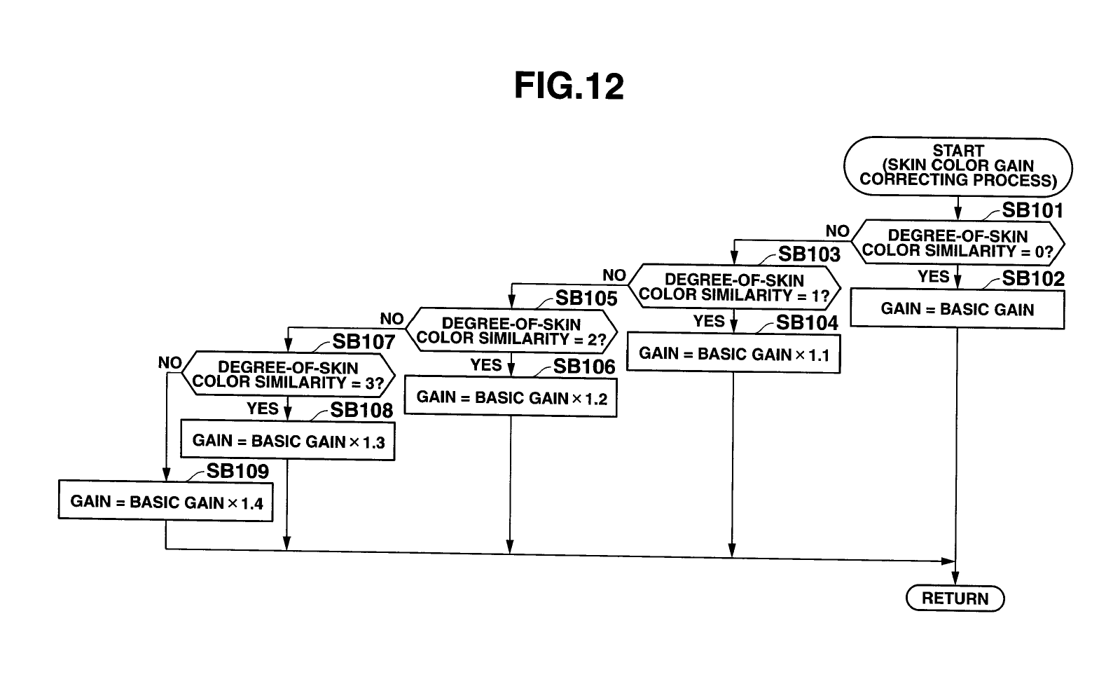

When the hue of the color of the block area of interest determined in the degree-of-color similarity determining process is skin color (step S3; “skin hue”), image sub-processor 52 performs a skin color gain correcting process (step S4). If the degree-of-skin-color similarity determined in the degree-of-color similarity determining process is 0, as shown in FIG. 12 (step SB101; YES), image sub-processor 52 handles thereference gain, calculated in step S1, as a final gain for the block area of interest without correcting the basis gain (step SB102).

If the degree-of-skin color similarity determined in the degree-of-color similarity-degree determining process is 1 (step SB101; NO, SB103; YES), image sub-processor 52 multiplies the basis gain calculated in step S1 by 1.1, thereby correcting the basis gain, and employs the corrected gain as a final gain for the block area (step SB104). If the degree-of-skin color similarity is 2 (step SB103; NO, step SB105; YES), image sub-processor 52 multiplies the basis gain by 1.2, thereby correcting the basis gain, and employs the corrected gain as a final gain for the block area (step SB106).

If the degree-of-skin color similarity is 3 (step SB105; N0, SB107; YES), image sub-processor 52 multiplies the basis gain by 1.3, thereby correcting the basis gain, and employs the corrected gain as a final gain for the block area (step SB108). If the degree-of-skin color similarity is 4 (step SB107; NO), image sub-processor 52 multiplies the basis gain by 1.4, thereby correcting the basis gain, and employs the corrected gain as a final gain for the block area (step SB109).

That is, in the skin color gain correcting process, image sub-processor 52 corrects the basis gain calculated in step S1, using a correction factor depending on the degree-of-skin color similarity of the hue of the block area of interest to the reference skin color. In the correction of the basis gain, image sub-processor 52 enlarges a correcting coefficient by which the basis gain is multiplied, in proportion to the degree-of-skin color similarity, which increases the basis gain as the hue of the block area is closer to the reference skin color.

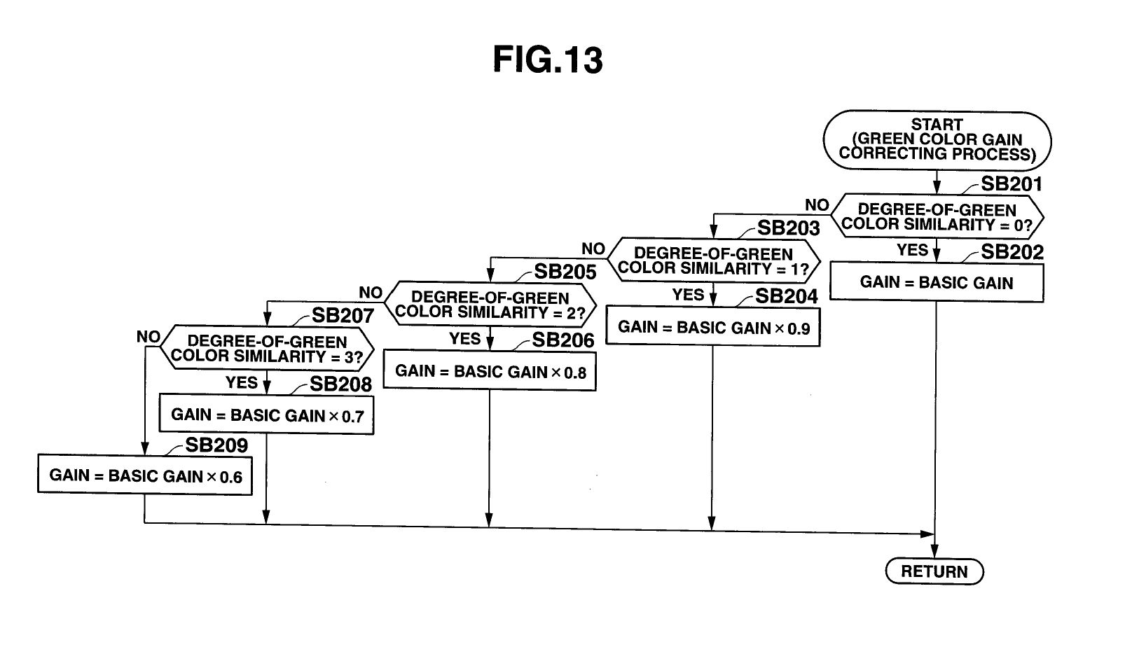

As shown in FIG. 7, if the hue of the color of the block area is green color (step S3; “green”), image sub-processor 52 performs a green gain correcting process (step S5). If the degree-of-green color similarity determined in this process is 0 (step SB201; YES), as shown in FIG. 13, image sub-processor 52 employs the basis gain, calculated in step S1, as it is as a final gain for the block area without correcting the basis gain (step SB 202).

If the degree-of-green color similarity determined in the degree-of-color similarity determining process is 1 (step SB201; NO, step SB203; YES), image sub-processor 52 corrects the basis gain by multiplying the basis gain calculated in step S1 by 0.9, and then employs the corrected gain as a final gain for the block area (step SB204). If the degree-of-green color similarity is 2 (step SB203; NO, step SB205; YES), image sub-processor 52 corrects the basis gain by multiplying the basis gain by 0.8, thereby correcting the basis gain, and employs the corrected gain as a final gain for the block area (step SB206).

If the degree-of-green color similarity is 3 (step SB205; NO, step SB207; YES), image sub-processor 52 corrects the basis gain by multiplying the basis gain by 0.7, and then employs the corrected gain as a final gain for the block area (step SB208). If the degree-of-green color similarity is 4 (step SB207; NO), image sub-processor 52 corrects the basis gain by multiplying the basis gain by 0.6, and employs the corrected gain as a final gain for the block area (step SB209).

That is, in the green color gain correcting process, image sub-processor 52 corrects the basis gain calculated in step S1, using a correction coefficient corresponding to the degree-of-green color similarity of the block area. Note that in the green color gain correcting process, image sub-processor 52 reduces the correction factor, by which the basis gain is multiplied, in proportion to the degree of green color similarity of the block area, thereby decreasing the basis gain as the hue of the block area of interest is closer to the reference green color, unlike in the skin color gain correcting process.

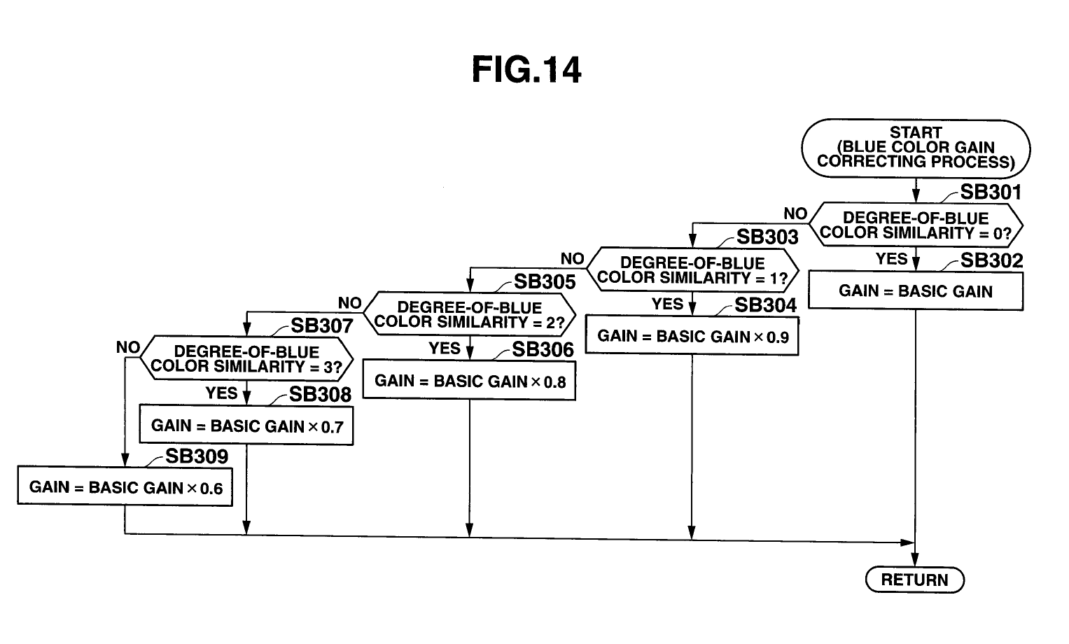

As shown in FIG. 7, if the hue of the color of the block area is blue color (step S3; “blue”), image sub-processor 52 performs a blue color gain correcting process (step S6). In this process, if the degree-of-blue color similarity determined in the color similarity-degree determining process is 0 (step SB301; YES), as shown in FIG. 14, image sub-processor 52 employs the basis gain calculated in step S1 as it is as a final gain for the block area without correcting the basis gain (step SB302).

If the degree-of-blue color similarity determined in the degree-of-color similarity-degree determining process is 1 (step SB301; NO, step SB303; YES), image sub-processor 52 multiplies the basis gain calculated in step. S1 by 0.9, thereby correcting the basis gain, and then employs the corrected gain as a final gain for the block area of interest (step SB304). If the degree-of-green color similarity is 2 (step SB303; NO, step SB305; YES), image sub-processor 52 multiplies the basis gain by 0.8, thereby correcting the basis gain, and then employs the corrected gain as a final gain for the block area (step SB306).

If the degree-of-blue color similarity is 3 (step SB305; NO, step SB307; YES), image sub-processor 52 multiplies the basis gain by 0.7 thereby correcting the basis gain, and then employs the corrected gain as a final gain for the block area (step SB308). If the degree-of-blue color similarity is 4 (step SB307; NO), image sub-processor 52 multiplies the basis gain by 0.6, thereby correcting the basis gain, and employs the corrected gain as a final gain for the block area (step SB309).

That is, in the blue gain correcting process, image sub-processor 52 corrects the basis gain calculated in step S1, using a correction coefficient corresponding to the degree-of-blue color similarity of the block area of interest. Also, in the blue gain correcting process, image sub-processor 52 reduces the correction coefficient, by which the basis gain is multiplied, in proportion to the degree-of-blue color similarity like in the green color gain correcting process, thereby decreasing the basis gain as the hue of the color of the block area is closer to the reference blue color.

As shown in FIG. 7, when the hue of the color of the block area of interest checked in step S3 is one to be not processed (step S3; “non-processed color”), image sub-processor 52 determines the basis gain calculated in step S1, as it is, as a final gain for the block area (step S7).

Then, image sub-processor 52 performs the following process in gain calculator 122. First, image sub-processor 52 sets the gain, calculated or determined in accordance with the color of the block area in steps S3-S7, as a representative gain for the block area (step S8). Subsequently, if there is a block area in which no representative gain is set yet (step S9; YES), image sub-processor 52 specifies that block as being to be processed (step S10), and then move on to step S1 to perform all the steps mentioned above repeatedly on that block.

After a representative gain is set in each of the block areas of the image of interest (step S9; NO), image sub-processor 52 sets the representative gain for each block area as a correction gain G_lev (x, y) for a central pixel of that block area (step S11), and then sets the gain calculated in the method mentioned above, as a correction gain for all of (peripheral) pixels other than the central pixel in that block area (step S12).

As described above, in the gradation correction process, image sub-processor 52 acquires a basis gain G_lev, for each of the block areas of the image of interest, which will be a reference correction for the brightness of each of the pixels of that block area, sets a correction gain G_lev (x, y) for each of the pixels of that block area based on the basis gain for that block area, corrects the brightness of that pixel in accordance with its set correction gain, thereby correcting the gradation of the image of interest.

Image sub-processor 52 calculates a basis gain for each block area, using the gain function in which the averaged value value V_av of that block area is a parameter. Thus, basically, as the averaged value value V_av of that block area is lower, the value of the basis gain is higher and vice versa.

Thus, in the gradation correction process, the brightness of a dark area of the image of interest can be increased. Thus, in digital camera 1, an image of a person's face in which satisfactory brightness is ensured is obtainable, for example, even under backlight.

In the gradation correction process, when setting a correction gain for a respective one of the pixels of each block area of the image, image sub-processor 52 temporarily corrects the basis gain for that block area in accordance with the degree of similarity of the hue of that block area to a corresponding one of the reference skin, green and blue colors, and then sets a correction gain for the respective pixel based on the corrected basis gain. That is, image sub-processor 52 sets, as a correction gain for each pixel, a gain depending on the degree of color similarity of the block area, which includes that pixel, to the corresponding reference color.

When the basis gain for each block is corrected depending on the degree-of-color similarity and the hue of the block area corresponds to the reference skincolor, image sub-processor 52 increases the basis gain for the block area in proportion to the degree of similarity of the hue of the block area to the reference skin color. When the hue of the block area corresponds to the reference green or blue color, image sub-processor 52 decreases the basis gain for the block area in inverse proportion to the degree of similarity of the block area to the reference green or bluecolor.

Thus, in the gradation correction process, if the image of interest includes a person image, the person's skin color in the image can be corrected to a brighter skin color by brightening an area of the image corresponding to the person's skin area. If the image includes an image of a tree's leaves, the color of the image of a tree's leaves can be corrected to a thicker green color by darkening an area of the image of a tree's leaves. If the image of interest includes an image of the sky, the color of the sky can be corrected to a thicker blue color by darkening an area of the sky image.

That is, in the gradation correction process, not only dark parts of the image of interest can be brightened, but also appropriate brightness for each color satisfying many users' common preference can be ensured in the corrected image. Thus, an image satisfying many users' preferences can be obtained by digital camera 1.

In the gradation correction process, the color component (R, G and B) values of the RGB data of each of the pixels of the image of interest produced in the de-mosaic process are corrected individually in accordance with the correction gain set for that pixel, thereby correcting the brightness of that pixel. Thus, the following advantages are produced. When the hue of the block area of interest corresponds to the reference skin color in the gradation correction process, the saturation of an area of the image of interest corresponding to a person's skin can be increased in the corrected image in order to increase the basis gain for the block area in proportion to the degree of similarity of the hue of the block area to the reference skin color. Thus, in the corrected image, the skin color of the person's image is expressed clearly so as to satisfy many users' common preference.

The reason why such advantages are obtained is that the saturation S of each pixel is proportional to a difference between the maximum and minimum values MAX and MIN of the R, G and B color component values of that pixel (S=(MAX−MIN)/MAX). If the image of interest is the YUV data obtained in the YUV conversion process and even if the brightness of each pixel is increased by multiplying its brightness component value Y by its correction gain, the saturation of the block area whose hue is skin color in the corrected image does not increase because changes in the luminance component value Y do not influence changes in the saturation of that pixel.

In the gradation correction process, the degree of similarity of the hue of each block area to a corresponding one of the reference skin, green and blue colors is determined in a plurality of stages. Thus, a change in brightness between adjacent block areas of the corrected image is smoothed. Thus, the corrected image gives a natural impression.

In the gradation correction process, a correction gain for the central pixel of each block area is handled as a representative gain for the block area, and a correction gain for each of the peripheral pixels other than the central pixel in the block area is basically obtained by interpolation from a plurality of (4 at maximum) pixels adjacent to that peripheral pixel. Even this method smoothes a change in brightness between adjacent block areas of the corrected image. Thus, the corrected image gives a natural expression.

Although in the present embodiment the three different reference colors are illustrated which include skin, green and blue colors, they may be other ones. The number of those reference colors is not necessarily required to be plural, but may be 1 (unity) as the case may be.

In the present embodiment, the RGB data of the image whose gradation is to be corrected is converted to HSV data. Then, it is determined, based on the respective components (H, S and V) of the HSV data, which of the different reference colors the hue of each block area corresponds to and how much the degree of similarity of the hue of that block area to the corresponding reference color is. This determination may be made based on the respective components R, G and B of the RGB data and is not necessarily required to be made based on the HSV data.

The color determination criteria based on which it is determined which of the reference skin, green and blue colors the hue of each block area corresponds to, and the degree of color similarity determination criteria in accordance with which it is determined how much the hue of each block area is similar to the corresponding reference color are by way of example only, and the reference colors and degree-of-color similarity determination criteria may be changed as required.

In the present embodiment, the gradation correction process has been described in which the brightness of the dark area of the image of interest is increased basically. However, the present invention is applicable to image processing which only aims to ensure an appropriate brightness of each color satisfying many users' common preference in the image whose gradation is to be corrected.

In the present invention, the basis gain calculator 103 shown in the functional block diagram of FIG. 3 is not an indispensable element in the present invention and may be eliminated. In this case, the basis gain G_lev for each block area is required to be fixed to “1” beforehand and the basis gain corrector 121 of FIG. 3 is required to perform the same process as in the embodiment.

Although digital camera 1 including the image processor of the present invention has been illustrated, the present invention is applicable, for example, to image capture apparatus capable of recording moving images. In addition to digital cameras including a CCD, image capturing apparatus to which the present invention is applicable include digital cameras including a MOS (Complimentary Metal Oxide Semiconductor) solid image capturing device; digital cameras capable of capturing moving images as well as still images; and digital video cameras that capture moving images mainly.

The present invention also is applicable to any image processors capable of processing images stored as image data on any recording medium, in addition to the image capturing apparatus. These image processors include a printer that prints an image based on image data.

The image sub-processor 52 of FIG. 2 according to the present invention can be implemented by either an ASIC (Application Specified Integrated Circuit) or a combination of any computer including a CPU, a memory, and a program loaded on the memory.

Various modifications and changes may be made thereunto without departing from the broad spirit and scope of this invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

What is claimed is:

1. An image processor comprising:
a degree-of-color similarity determiner that determines, based on color information on all pixels of each of a plurality of block areas of an image whose gradation is to be corrected, a degree of similarity of the hue of that block area to a specified reference color;
a correction factor setter that sets, for each pixel, a correction factor corresponding to the degree of similarity of a hue of the block area determined by the determiner; and
a gradation corrector that corrects the brightness of that pixel based on the correction factor set for that pixel by the setter.

2. The image processor of claim 1, wherein the gradation corrector corrects a plurality of items of color component information on that pixel based on the correction factor set for that pixel by the correction factor setter.

3. The image processor of claim 1, wherein the degree-of-color similarity determiner determines, in a plurality of stages, the degree of similarity of the hue of that block area to the reference color.

4. The image processor of claim 1, wherein the degree-of-color similarity determiner determines the degree of similarity of the hue of that block area to the reference color, based on color information represented by predetermined component information, in a HSV color space, on each of the pixels of that block area where H, S and V represent hue, saturation and value, respectively.

5. The image processor of claim 4, wherein the predetermined component information comprises a plurality of items of component information on that pixel.

6. The image processor of claim 1, wherein the degree-of-color similarity determiner comprises:
a color determiner that determines, based on color information on all the pixels of that block area, which of a plurality of predetermined reference colors the hue of that block area corresponds to; and
a degree-of-color similarity determiner that determines the degree of similarity of the hue of that block area to the reference color based on color information on all the pixels of that block area and a degree-of-similarity determination criterion corresponding to the reference color to which the degree of similarity of the hue of that block area is determined by the color determiner.

7. The image processor of claim 6, wherein the color determiner determines, based on hue component information in a HSV color space which includes color information on all the pixels of that block area, which of a plurality of predetermined specified colors the hue of that block area corresponds to.

8. The image processor of claim 6, wherein the degree-of-color similarity determiner determines the degree of similarity of the hue of that block area to the reference color based on a predetermined degree-of-color similarity determination criterion corresponding to the reference color to which the degree of similarity of the hue of that block area is determined by the color determiner and a plurality of items of component information in a HSV color space which includes color information on all the pixels of that block area.

9. The image processor of claim 1, wherein the reference color includes at least one of reference skin, green and blue colors.

10. The image processor of claim 1, wherein the correction factor setter comprises:
a representative correction factor acquirer that acquires a representative correction factor corresponding to the degree of similarity of that block area to the reference color determined by the degree-of-color similarity determiner; and
a pixel factor acquirer that acquires a correction factor to be set individually for each of the pixels of that block area based on the representative correction factor of that block area acquired by the representative correction factor acquirer.

11. The image processor of claim 10, wherein the pixel factor acquirer acquires a correction factor to be set individually for each of the pixels of that block area based on the representative correction factor for that block area acquired by the representative correction factor acquirer and a representative correction factor acquired by the representative correction factor acquirer for another block area close to the respective pixels of that block area.

12. The image processor of claim 11, wherein the pixel factor acquirer acquires, as a correction factor for a central pixel in that block area, the representative correction factor for that block area, and a correction factor for a peripheral pixel around the central pixel in that block area by interpolation from the correction factor for the central pixel and a representative correction factor for another block area close to the peripheral pixel in that block area.

13. The image processor of claim 10, further comprising a basis gain acquirer that acquires, for each block area, a basis gain depending on a predetermined correction characteristic for correcting the brightness of each of the pixels of that block area based on information on the brightness of that pixel; and wherein:
the representative correction factor acquirer corrects the basis gain for that block area acquired by the basis gain acquirer in accordance with the degree of similarity of the hue of that block area to the reference color determined by the degree-of-color similarity determiner, and acquires the corrected basis gain as the representative correction factor.

14. The image processor of claim 13, wherein the representative correction factor acquirer increases the basis gain for that block area acquired by the basis gain acquirer in proportion to the degree of similarity of the hue of that block area to the reference color determined by the degree-of-color similarity determiner, and acquires the increased basis gain as the representative correction factor.

15. The image processor of claim 13, wherein the representative correction factor acquirer decreases the basis gain for that block area acquired by the basis gain acquirer in proportion to the degree of similarity of the hue of that block area to the reference color determined by the degree-of-color similarity determiner, and acquires the decreased basis gain as the representative correction factor.

16. A software program product embodied in a computer readable medium for causing a computer to function as:
a degree-of-color similarity determiner that determines, based on color information on all pixels of each of a plurality of block areas of an image whose gradation is to be corrected, a degree of similarity of the hue of that block area to a specified reference color;
a correction factor setter that sets, for each pixel, a correction factor corresponding to the degree of similarity of a hue of the block area determined by the determiner; and
a gradation corrector that corrects the brightness of that pixel based on the correction factor set for that pixel by the setter.
